(19) United States
(12) Patent Application Publication
(10) Pub. No.: US 2017/0043611 A1
(43) Pub. Date: Feb. 16, 2017

(54) WRITING IMPLEMENT ASSEMBLY

(71) Applicant: HZ Products B.V., Oud-Beijerland (NL)

(72) Inventor: Johannes Van Der Zande, Oud-Beijerland (NL)

(21) Appl. No.: 15/306,309

(22) PCT Filed: Apr. 24, 2015
(86) PCT No.: PCT/NL2015/050279

§ 371 Date: Oct. 24, 2016

(30) Foreign Application Priority Data
Apr. 25, 2014 (NL) 2012697

(51) Int. Cl. B43K 23/06; B65D 85/28; A45C 11/34

(52) U.S. Cl. CPC B43K 23/06; A45C 11/34; B65D 85/28

(57) ABSTRACT

The present invention relates to a writing instrument assembly. The invention relates more particularly to a writing instrument assembly comprising a plurality of writing instruments, such as pens or felt-tip pens, and a plurality of caps. The assembly comprises an elongate coupling device which is manufactured from a flexible material and wherein ends of the coupling device can be coupled to each other so that an annular coupling device is created. The invention is characterized in that the material of the coupling device is also resilient such that an external force has to be exerted on the coupling device in order to bend the coupling device from an elongate state to an annular state.

The present invention relates to a writing instrument assembly. The invention relates more particularly to a writing instrument assembly comprising a plurality of writing instruments, such as pens or felt-tip pens, and a plurality of caps.

Such assemblies are known. A drawback of these assemblies is the inconvenience which results when a cap comes loose from a pen or felt-tip pen and is subsequently lost. This problem particularly occurs with children. If a felt-tip pen or pen is not closed with a cap there is a danger of it drying out. A solution to the above stated problem is known from the prior art. In the known solution each cap is provided with an eye. The assembly is supplied with a cord which the user can pull through each cap to connect the caps together. This reduces the risk of a user losing a single cap. The writing instruments and caps can moreover be stored as one whole. Such a solution is described in WO 2010/130451 A1.

Another solution, which corresponds to the preamble of claim 1, is described in DE 26 24 708 A1 and comprises a substantially flat strip to which the caps are permanently connected. This strip can be bent so that an annular state is reached. The caps extend here in a direction parallel to an axial direction. It hereby becomes possible to use the caps as a type of stand. A drawback of this solution is that it is not always easy for a user to remove a felt-tip pen from a cap, particularly when all felt-tip pens are still in the cap. It has further been found that when a small number of felt-tip pens is still placed in the cap, a situation which occurs frequently with children, the stability of the stand decreases, whereby it may fall over.

It is an object of the present invention to provide an improvement to the above stated solution, wherein the stated drawbacks do not occur, or less so.

This object is achieved according to the invention with an assembly as defined in claim 1.

The assembly according to the invention comprises a plurality of writing instruments, such as pens or felt-tip pens, a plurality of caps for the writing instruments and an elongate coupling device which is manufactured from a flexible material and wherein ends of the coupling device can be coupled to each other so that an annular coupling device is created, wherein the coupling device is permanently and preferably fixedly connected to the plurality of caps. The coupling device is further configured to mutually couple the plurality of caps in a first coupling state, in which the coupling device is connected to each of the plurality of caps.

The material of the coupling device is also resilient such that an external force has to be exerted on the coupling device in order to bend the coupling device from an elongate state to an annular state, and wherein the coupling device with ends uncoupled and without exertion of an external force will bend back from the annular state to the elongate state, wherein in the elongate state and without exertion of an external force the caps of the writing instruments are all oriented in the same direction.

In the absence of an external force, such as a force exerted by a user but also other external forces such as gravitational force, the coupling device will be in the elongate state. The coupling device will be able to bend to some extent under the influence of gravitational force, particularly in the case of coupling devices suitable for large numbers of writing instruments.

Before using the assembly the user can bend the coupling device to the annular state. The writing instruments will hereby fan out and the user can easily remove the cap from an associated pen or felt-tip pen. In order to store the plurality of writing instruments and caps the user places the writing instruments in the associated caps and the user uncouples the ends of the coupling device, as a result of which the coupling device will spring back to the elongate state. In this state all pens or felt-tip pens lie parallel adjacently of each other and form a compact whole. In this situation it is more difficult for a user to grip an individual pen or felt-tip pen. However, owing to the compactness of the assembly it is easier to store.

It is recommended that the coupling device is manufactured integrally with the caps. This creates the option of placing the assembly in coupled state in the packaging. This provides convenience of use on the one hand and the production process is hereby facilitated on the other.

In an embodiment the assembly further comprises a packaging for the plurality of writing instruments. The packaging can comprise a sleeve-like element here in which the plurality of writing instruments of the assembly can be placed in the first coupled state and wherein the coupling device closes the sleeve-like element when the writing instruments are placed in the sleeve-like element. The sleeve-like element and the coupling device can be provided here with locking means for mutually locking the coupling device and the sleeve-like element. It is however also possible for the writing instruments, the caps and the coupling device to be all placed in the sleeve-like element. This latter can for instance be provided with a flap for closing the sleeve-like element.

In another embodiment the packaging is provided with a base element and a cover element, wherein the cover element and the base element can be placed on each other for the purpose of forming the packaging, wherein the base element and/or the cover element is preformed for the purpose of fittingly receiving the plurality of writing instruments of the assembly in the first coupled state. The base element and/or the cover element can thus comprise an indentation corresponding to a shape of the writing instruments. The writing instruments will hereby remain in place after being placed in the base element and/or the cover element. The base element and/or the cover element can further comprise a recess for receiving the coupling device.

The coupling device can be tubular or beam-like and can be provided with a slot, wherein each of the plurality of caps comprises a case for closing one of the plurality of writing instruments, as well as a stem connected to the case and a head part connected to the stem. In the first coupled state the head part is received here in the coupling device and the stem protrudes through the slot. The head part and/or the case then lies against a respective inner wall or outer wall of the coupling device for the purpose of limiting the movement of the cap to a movement in a longitudinal direction of the slot.

The above stated slot and shape of the head part and/or the case achieve that the writing instruments lie substantially in one plane. This increases the convenience of use of the assembly.

In a further embodiment the assembly comprises closing elements for closing ends of the coupling device in order to close the plurality of caps in the tubular or beam-like coupling device between the ends of the coupling device.

In an embodiment the coupling device is provided on ends thereof with coupling elements for coupling the ends. These coupling elements can be identical to the above stated closing elements. The coupling device can for instance be shaped as a hollow tube. In this embodiment the coupling elements and closing elements can be formed by a rod-like element which is placed clampingly in the hollow tube of the coupling device. The hollow tube is hereby closed and the ends of the hollow tube are coupled.

The invention will be discussed in more detail hereinbelow with reference to the accompanying figures, wherein:

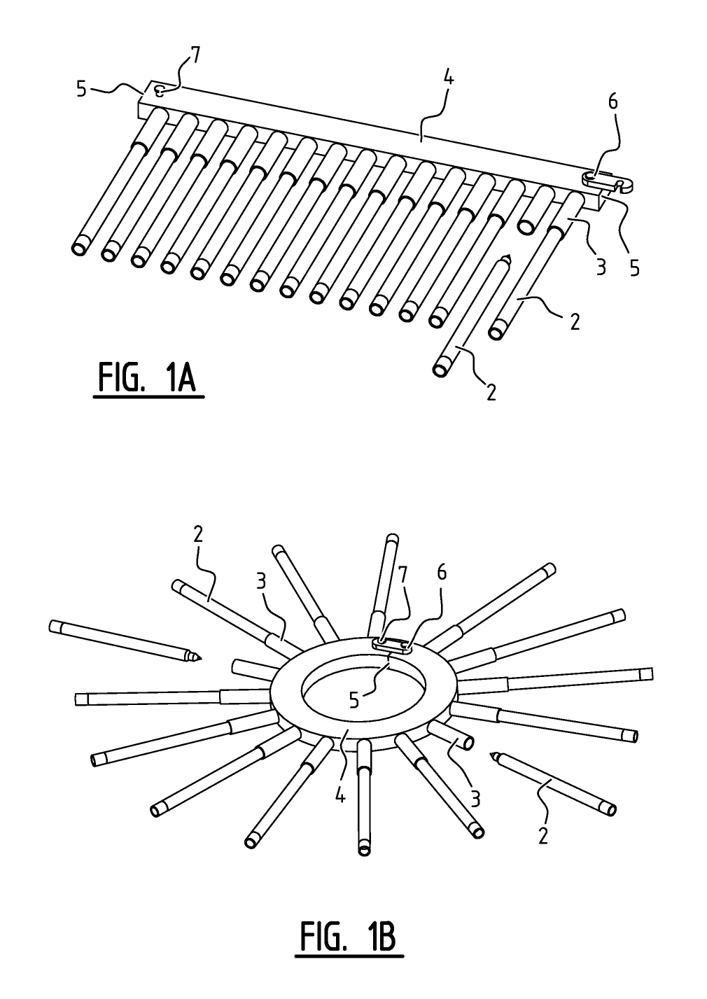

FIGS. 1A and 1B show a first embodiment of the assembly according to the invention in respectively elongate state and annular state;

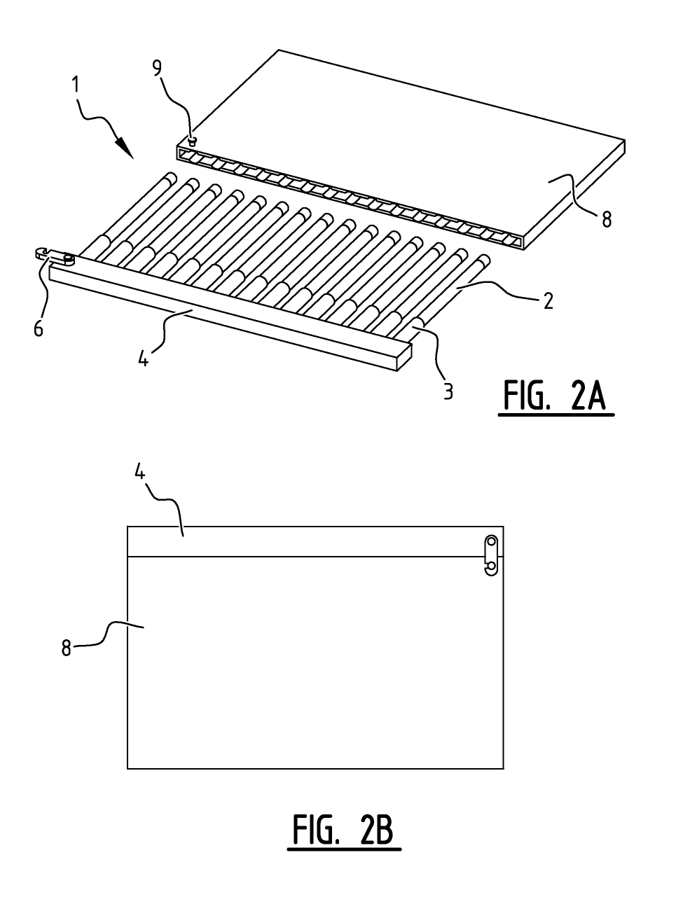

FIGS. 2A and 2B show the first embodiment combined with a packaging in respectively an uncoupled and coupled situation;

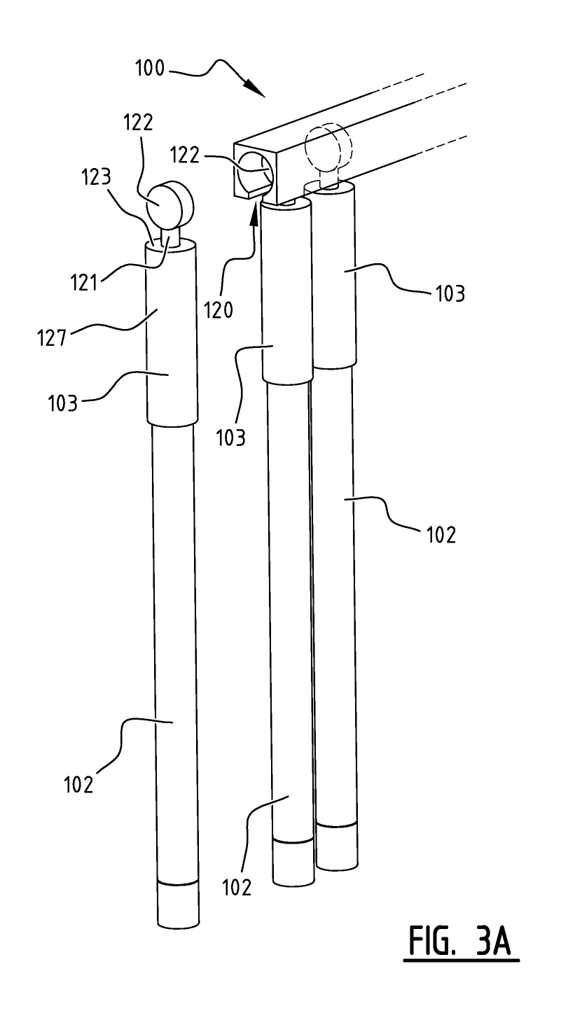

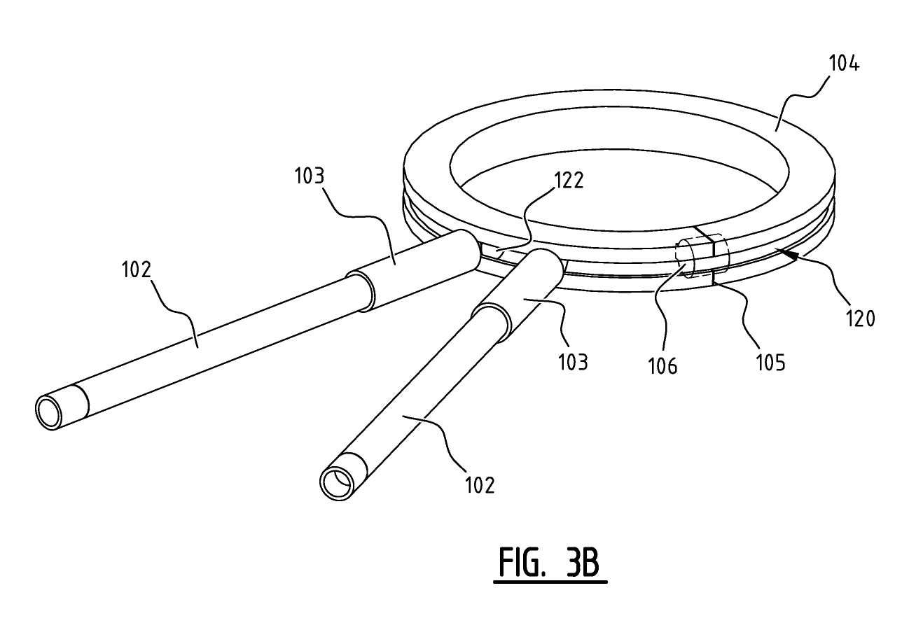

FIGS. 3A and 3B show a second embodiment of the assembly according to the invention in respectively elongate state and annular state;

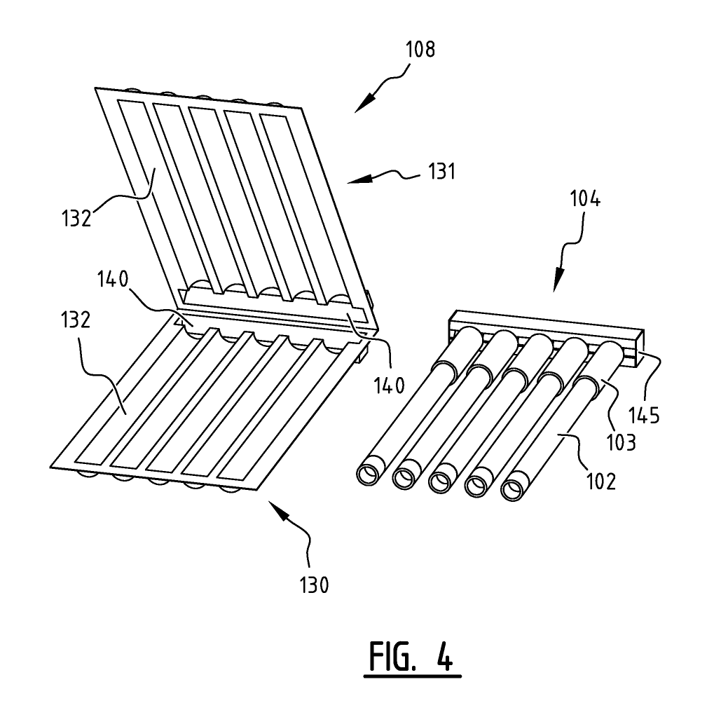

FIG. 4 shows the second embodiment combined with a further packaging;

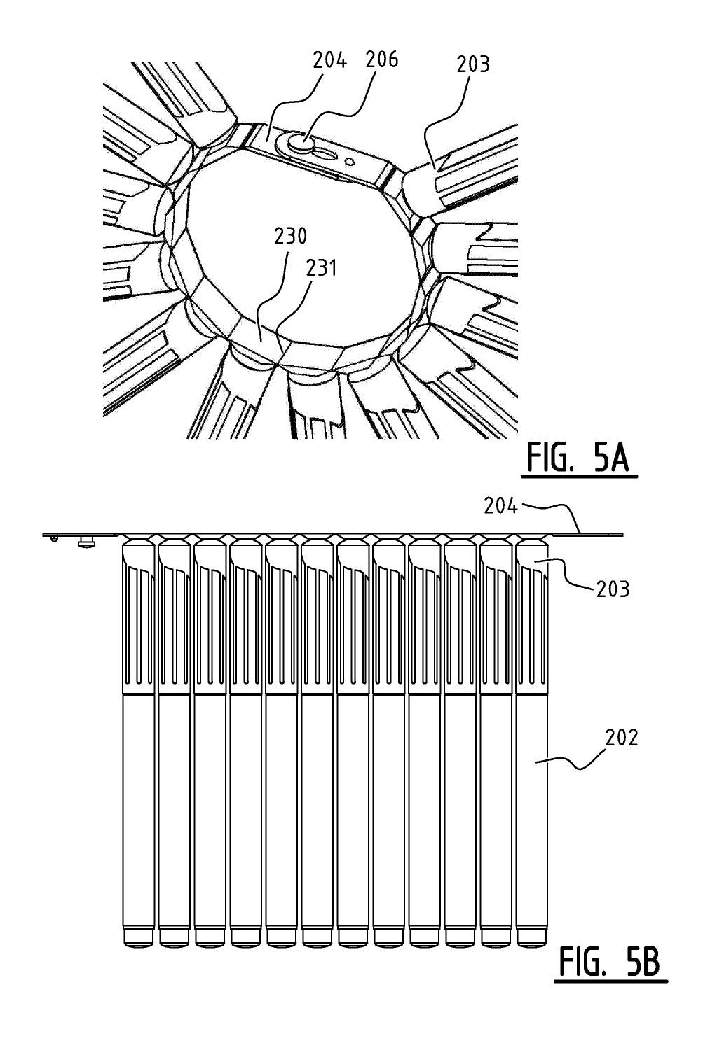

FIGS. 5A and 5B show a third embodiment in respectively an annular coupled state and a straight uncoupled state;

FIG. 6 shows a further embodiment of a packaging; and

FIGS. 7 and 8 shows detail views of the packaging in FIG. 6.

FIG. 1A shows an embodiment of an assembly according to the present invention. Assembly 1 comprises a plurality of writing instruments, here in the form of felt-tip pens 2, with associated caps 3. Assembly 1 further comprises a coupling device 4 for coupling caps 3. In the embodiment of FIG. 1 coupling device 4 and caps 3 are manufactured integrally.

FIG. 1A shows the elongate state which is suitable for storing assembly 1. FIG. 1B shows an annular state which corresponds to a position of use. Coupling device 4 is bent here to form a ring and ends 5 of coupling device 4 are connected by means of a hook 6 which engages on pin 7. Other types of closure, such as a magnetic closure wherein magnetic or magnetizable material is received in ends 5, are not precluded.

FIG. 2A shows the embodiment of FIG. 1A combined with a packaging 8 in the form of a sleeve-like element. Packaging 8 is provided here with a pin 9. Packaging 8 further has an indentation 10 on the inner side and/or outer side, which ensures that felt-tip pens 2 can be placed in form-fitting manner in packaging 8.

FIG. 2B shows how assembly 1 is placed in packaging 8. Hook 6 is used here to engage round pin 9, whereby assembly 1 is locked in packaging 8. It can also be seen how coupling device 4 closes packaging 8.

FIGS. 3A and 3B show a second embodiment of the assembly according to the invention in respectively elongate state and annular state.

In contrast to the embodiment of FIG. 1A, coupling device 104 of assembly 100 in FIG. 3A is not integrally connected to caps 103 associated with felt-tip pens 102. Coupling device 104 is provided with a slot 120. Caps 103 further comprise a case 127 for closing felt-tip pen 102 which is connected to a stem 121, wherein each stem 121 is connected to a head part 122. Each head part 122 can be placed here in coupling device 104 via end 105. After placing of head part 122 the movement thereof, as well as the movement of the associated felt-tip pen 102, is limited to the longitudinal direction of slot 120. This is caused by the shape of head part 122 in combination with the inner wall of coupling device 104 and/or upper side 123 of cap 103. Coupling device 104 is hereby as it were clamped between head part 122 and upper side 123 of cap 103.

FIG. 3B shows assembly 100 in annular state. Use is made here of a rod-like element 106 which is placed clampingly in coupling device 104 in order to couple ends 105 of assembly 100. This element also serves to confine felt-tip pens 102 placed on coupling device 104. If desired, coupling device 104 can be supplied in a situation where caps 103 are already coupled to coupling device 104 and wherein ends 105 are closed with closing element 145 intended for the purpose, see FIG. 4.

FIG. 4 shows the second embodiment combined with a further packaging 108. This packaging comprises a base element 130 and a cover element 131 which are both provided with an indentation 132 corresponding to the shape of felt-tip pens 102 and/or caps 103 of assembly 100. Packaging 108 is further provided with a recess 140 in which coupling device 104 can be placed.

Owing to the preferably permanent connection between caps 103 and coupling device 104 assembly 100 of FIG. 4 can be stored in simple manner, preferably in packaging 108. It is further noted that the assembly of caps 103, felt-tip pens 102 and coupling device 104 can be embodied as shown in FIGS. 1A and 3A.

FIGS. 5A and 5B show a third embodiment in respectively an annular coupled state and a straight uncoupled state. In this embodiment coupling device 204 comprises a substantially flat strip which comprises a plurality of segments 230. Segments 230 are mutually connected here at connecting lines 231. The material thickness of the strip is also smaller at these lines than at other parts of the strip.

The strip is provided at its ends with coupling means 206 with which the ends can be mutually coupled, as shown in FIG. 5A. The strip is made here of a flexible and resilient material so that the strip can be bent to an annular state, as shown in FIG. 5A, and wherein the strip bends back to a straight position, as shown in FIG. 5B, when the ends of the strip are uncoupled and no external force is further applied.

In this embodiment caps 203 are permanently and fixedly connected to the strip, for instance in that they are integrally connected to the coupling device. Similarly to the embodiments in FIGS. 1B and 3B, caps 203 extend radially, whereby a fanning out of felt-tip pens 202 is obtained. It is also possible to use strengthening means for the purpose of limiting or preventing the flexibility in axial direction. Ribs can thus be applied, for instance thickened portions, which are incorporated in axial direction into the strip. This further achieves that the strip can only be bent to the shown annular state.

FIG. 6 shows a packaging 308 which is suitable for packaging the assemblies shown in the foregoing figures. Packaging 308 is embodied for this purpose as a double blister pack comprising two halves 308A and 308B, see FIG. 7. These can each comprise a semi cylindrical recess 370 between which a felt-tip pen 302 or cap 303 can be clamped. A recess can also be provided for the purpose of receiving coupling device 304.

Packaging 308 further comprises two recesses 350 with which a user can easily take hold of packaging 308. It is also possible for recesses 350 to be embodied as continuous openings.

In order to close the two halves 308A, 308B of packaging 308. packaging 308 is provided with a clamping connection 340 which is shown in more detail in FIG. 8. An outer end of half 308A can be clamped here round an outer end of half 308B. Other or further means for closing halves 308A and 308B can be provided.

Packaging 308 forms an attractive whole which moreover provides the advantage that it can be used as container for storing the felt-tip pens. It is also possible to provide packaging 308 with information, for instance in the form of advertising, a brand or company name 360. This information can also show a schematic view of the coupling device in annular state. By making use of a transparent material a user can further see that the caps of the felt-tip pens are connected to the coupling device.

It will be apparent to the skilled person that various modifications are possible without departing from the scope of protection of the present invention defined by the following claims. It is particularly noted that the annular state is not limited to states in which the coupling device is bent into a circle. Other shapes are likewise possible, wherein the ends of the coupling device can be brought close to each other for mutual coupling.

1. An assembly, comprising:
a plurality of writing instruments, such as pens or felt-tip pens;
a plurality of caps for the writing instruments;
an elongate coupling device which is manufactured from a flexible material and wherein ends of the coupling device are coupleable to each other so that an annular coupling device is created, wherein the coupling device is permanently connected to the plurality of caps;
wherein the coupling device is configured to mutually couple the plurality of caps in a first coupling state, in which the coupling device is connected to each of the plurality of caps;
wherein the material of the coupling device is resilient such that an external force has to be exerted on the coupling device in order to bend the coupling device from an elongate state to an annular state,
wherein the coupling device with ends uncoupled and without exertion of an external force will bend back from the annular state to the elongate state,
wherein in the elongate state and without exertion of an external force the caps of the writing instruments are all oriented in the same direction; and
wherein in the annular state the caps coupled to the coupling device extend in the radial direction.

2. Assembly as claimed in claim 1, wherein the coupling device is manufactured integrally with the caps.

3. Assembly as claimed in claim 1, further comprising a packaging for the plurality of writing instruments.

4. Assembly as claimed in claim 3, wherein the packaging comprises a sleeve-like element in which the plurality of writing instruments of the assembly can be placed in the first coupled state and wherein the coupling device closes the sleeve-like element when the writing instruments are placed in the sleeve-like element.

5. Assembly as claimed in claim 4, wherein the sleeve-like element and the coupling device are provided with locking means for mutually locking the coupling device and the sleeve-like element.

6. Assembly as claimed in claim 3, wherein the packaging comprises a base element and a cover element, wherein the cover element and the base element can be placed on each other for the purpose of forming the packaging, wherein the base element and/or the cover element is preformed for the purpose of fittingly receiving the plurality of writing instruments of the assembly in the first coupled state.

7. Assembly as claimed in claim 6, wherein a wall of at least one of the base element and the cover element comprises an indentation corresponding to a shape of the writing instruments.

8. Assembly as claimed in claim 6, wherein at least one of the base element and the cover element comprise a recess for receiving the coupling device.

9. Assembly as claimed in claim 1, wherein the coupling device is tubular or beam-like and provided with a slot, wherein each of the plurality of caps:
comprises a case for closing one of the plurality of writing instruments;
a stem connected to the case;
a head part connected to the stem; and
wherein in a first coupled state the head part is received in the coupling device and the stem protrudes through the slot, wherein at least one of the head part and the case connects to a respective inner wall or outer wall of the coupling device to limit the movement of the cap to a movement in a longitudinal direction of the slot.

10. Assembly as claimed in claim 9, further comprising closing elements for closing ends of the coupling device to close the plurality of caps in the tubular or beam-like coupling device between the ends of the coupling device.

11. Assembly as claimed in claim 1, wherein the coupling device is provided on ends thereof with coupling elements for coupling the ends.
